(19) United States
(12) Patent Application Publication
(10) Pub. No.: US 2026/0313552 A1
(43) Pub. Date: Oct. 8, 2026

(54) LOWER POWER WAKE-UP SIGNAL PAGING

(71) Applicant: NOKIA TECHNOLOGIES OY, Espoo (FI)

(72) Inventors: Jorma Johannes KAIKKONEN, Oulu (FI); Jussi-Pekka KOSKINEN, Oulu (FI); Chunli WU, Beijing (CN)

(21) Appl. No.: 19/483,359

(22) PCT Filed: May 11, 2023
(86) PCT No.: PCT/CN2023/093682

§ 371 Date: Nov. 11, 2025

(51) Int. Cl. H04W 52/02; H04W 76/28

(52) U.S. Cl. CPC H04W 52/0235; H04W 76/28

(57) ABSTRACT

The present disclosure relates to low power wake-up signal (LP-WUS) paging. In an aspect, a terminal device obtains a first paging configuration for a first type of terminal devices which are low power wake-up signal (LP-WUS) capable devices, wherein the first paging configuration is different from a second paging configuration for a second type of terminal devices which are LP-WUS incapable devices. The terminal device monitors a paging message according to the first paging configuration, based on determining that the apparatus is a LP-WUS capable device. In this way, beneficial effects, such as reducing paging latency for LP-WUS based operation, may be achieved.

### FIELD

Example embodiments of the present disclosure generally relate to the field of telecommunication, and in particular, to a terminal device, a network device, methods, apparatuses, and a computer-readable storage medium for low power wake-up signal (LP-WUS) paging.

### BACKGROUND

5G systems are designed and developed targeting for both mobile telephony and vertical use cases. Besides latency, reliability, and availability, UE energy efficiency is also critical to 5G. Currently, 5G devices may have to be recharged per week or day, depending on individual's usage time. In general, 5G devices consume tens of milliwatts in RRC idle/inactive state and hundreds of milliwatts in RRC connected state. Design to prolong battery life is a necessity for improving energy efficiency as well as for better user experience.

There has been proposed that a separate low-power wake-up receiver (LP-WUR) is designed at the UE, and the main radio of the UE can be in a sleep mode (or even powered off) for power saving and be activated only upon the reception of the wake-up signal (WUS) from the network. In 5G study items on WUS, it has been agreed that latency impact of low-power WUR/WUS should be paid attention to and be studied.

### SUMMARY

In general, example embodiments of the present disclosure provide a solution for LP-WUS paging.

In a first aspect, there is provided a terminal device. The terminal device comprises at least one processor and at least one memory storing instructions that, when executed by the at least one processor, cause the terminal device at least to: obtain a first paging configuration for a first type of terminal devices which are low power wake-up signal (LP-WUS) capable devices, wherein the first paging configuration is different from a second paging configuration for a second type of terminal devices which are LP-WUS incapable devices; and monitor a paging message according to the first paging configuration, based on determining that the terminal device is a LP-WUS capable device.

In a second aspect, there is provided a network device. The network device comprises at least one processor and at least one memory storing instructions that, when executed by the at least one processor, cause the network device at least to: determine a first paging configuration for a first type of terminal devices which are low power wake-up signal (LP-WUS) capable devices, wherein the first paging configuration is different from a second paging configuration for a second type of terminal devices which are LP-WUS incapable devices; and transmit a paging message to the terminal device according to the first paging configuration, based on determining that the terminal device is a LP-WUS capable device.

In a third aspect, there is provided a method. The method comprises: obtaining, at a terminal device, a first paging configuration for a first type of terminal devices which are low power wake-up signal (LP-WUS) capable devices, wherein the first paging configuration is different from a second paging configuration for a second type of terminal devices which are LP-WUS incapable devices; and monitoring a paging message according to the first paging configuration, based on determining that the terminal device is a LP-WUS capable device.

In a fourth aspect, there is provided a method. The method comprises: determining, at a network device, a first paging configuration for a first type of terminal devices which are low power wake-up signal (LP-WUS) capable devices, wherein the first paging configuration is different from a second paging configuration for a second type of terminal devices which are LP-WUS incapable devices; and transmitting a paging message to the terminal device according to the first paging configuration, based on determining that the terminal device is a LP-WUS capable device.

In a fifth aspect, there is provided an apparatus. The apparatus comprises: means for obtaining, at a terminal device, a first paging configuration for a first type of terminal devices which are low power wake-up signal (LP-WUS) capable devices, wherein the first paging configuration is different from a second paging configuration for a second type of terminal devices which are LP-WUS incapable devices; and means for monitoring a paging message according to the first paging configuration, based on determining that the terminal device is a LP-WUS capable device.

In a sixth aspect, there is provided an apparatus. The apparatus comprises: means for determining, at a network device, a first paging configuration for a first type of terminal devices which are low power wake-up signal (LP-WUS) capable devices, wherein the first paging configuration is different from a second paging configuration for a second type of terminal devices which are LP-WUS incapable devices; and means for transmitting a paging message to the terminal device according to the first paging configuration, based on determining that the terminal device is a LP-WUS capable device.

In a seventh aspect, there is provided a non-transitory computer-readable storage medium comprising instructions. The instructions, when executed by an apparatus, cause the apparatus to perform at least the following: obtaining a first paging configuration for a first type of terminal devices which are low power wake-up signal (LP-WUS) capable devices, wherein the first paging configuration is different from a second paging configuration for a second type of terminal devices which are LP-WUS incapable devices; and monitoring a paging message according to the first paging configuration, based on determining that the terminal device is a LP-WUS capable device.

In an eighth aspect, there is provided a non-transitory computer-readable storage medium comprising instructions. The instructions, when executed by an apparatus, cause the apparatus to perform at least the following: determining a first paging configuration for a first type of terminal devices which are low power wake-up signal (LP-WUS) capable devices, wherein the first paging configuration is different from a second paging configuration for a second type of terminal devices which are LP-WUS incapable devices; and transmitting a paging message to the terminal device according to the first paging configuration, based on determining that the terminal device is a LP-WUS capable device.

In a ninth aspect, there is provided a computer program comprising instructions, which, when executed by an apparatus, cause the apparatus at least to: obtain a first paging configuration for a first type of terminal devices which are low power wake-up signal (LP-WUS) capable devices, wherein the first paging configuration is different from a second paging configuration for a second type of terminal devices which are LP-WUS incapable devices; and monitor a paging message according to the first paging configuration, based on determining that the terminal device is a LP-WUS capable device.

In a tenth aspect, there is provided a computer program comprising instructions, which, when executed by an apparatus, cause the apparatus at least to: determine a first paging configuration for a first type of terminal devices which are low power wake-up signal (LP-WUS) capable devices, wherein the first paging configuration is different from a second paging configuration for a second type of terminal devices which are LP-WUS incapable devices; and transmit a paging message to the terminal device according to the first paging configuration, based on determining that the terminal device is a LP-WUS capable device.

In an eleventh aspect, there is provided a terminal device. The terminal device comprises: obtaining circuitry configured to obtain a first paging configuration for a first type of terminal devices which are low power wake-up signal (LP-WUS) capable devices, wherein the first paging configuration is different from a second paging configuration for a second type of terminal devices which are LP-WUS incapable devices; and monitoring circuitry configured to monitor a paging message according to the first paging configuration, based on determining that the terminal device is a LP-WUS capable device.

In a twelfth aspect, there is provided a network device. The network device comprises: transmitting circuitry configured to determine a first paging configuration for a first type of terminal devices which are low power wake-up signal (LP-WUS) capable devices, wherein the first paging configuration is different from a second paging configuration for a second type of terminal devices which are LP-WUS incapable devices; and transmitting circuitry configured to transmit a paging message to the terminal device according to the first paging configuration, based on determining that the terminal device is a LP-WUS capable device.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example of a network environment in which some example embodiments of the present disclosure may be implemented;

FIG. 1B illustrates a schematic diagram of UE operations with low-power wake-up receiver (WUR) based on which some example embodiments of the present disclosure may be implemented;

FIG. 2 illustrates a flowchart illustrating a communication process in accordance with some example embodiments of the present disclosure;

FIG. 3 illustrates a flowchart of an example method implemented at a first device in accordance with some embodiments of the present disclosure;

FIG. 4 illustrates another flowchart of an example method implemented at a second device in accordance with some embodiments of the present disclosure;

FIG. 5 illustrates a simplified block diagram of a device that is suitable for implementing some example embodiments of the present disclosure; and

FIG. 6 illustrates a block diagram of an example of a computer-readable medium in accordance with some example embodiments of the present disclosure.

Throughout the drawings, the same or similar reference numerals represent the same or similar elements.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the fourth generation (4G), 4.5G, the fifth generation (5G) communication protocols, sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology. In the following description, the terms “network device” and “network node” may be used interchangeably.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As described above, 5G systems are designed and developed targeting for both mobile telephony and vertical use cases. Besides latency, reliability, and availability, UE energy efficiency is also critical to 5G. Currently, 5G devices may have to be recharged per week or day, depending on individual's usage time. In general, 5G devices consume tens of milliwatts in RRC idle/inactive state and hundreds of milliwatts in RRC connected state. Design to prolong battery life is a necessity for improving energy efficiency as well as for better user experience.

There has been proposed that a separate low-power (LP) wake-up receiver (WUR) is designed at the UE, and the main radio of the UE can be in a sleep mode (or even powered off) for power saving and be activated only upon the reception of the wake-up signal (WUS) from the network.

RAN has agreed study item (RP-222644) on low-power Wake-up Signal and Receiver for NR with the following objectives:

4.1 Objective of SI
As opposed to the work on UE power savings in previous releases, this study will not
require existing signals to be used as WUS. All WUS solutions identified shall be
able to operate in a cell supporting legacy UEs. Solutions should target substantial
gains compared to the existing Rel-15/16/17 UE power saving mechanisms. Other
aspects such as detection performance, coverage, UE complexity, should be covered
by the evaluation.
The study item includes the following objectives:
Identify evaluation methodology (including the use cases) & KPIs [RAN1]
Primarily target low-power WUS/WUR for power-sensitive, small
form-factor devices including IoT use cases (such as industrial sensors,
controllers) and wearables
Other use cases are not precluded
Study and evaluate low-power wake-up receiver architectures [RAN1, RAN4]
Study and evaluate wake-up signal designs to support wake-up receivers [RAN1,
RAN4]
Study and evaluate L1 procedures and higher layer protocol changes needed to
support the wake-up signals [RAN2, RAN1]
Study potential UE power saving gains compared to the existing Rel-15/16/17 UE
power saving mechanisms, the coverage availability, as well as latency impact of
low-power WUR/WUS. System impact, such as network power consumption,
coexistence with non-low-power-WUR UEs, network coverage/capacity/resource
overhead should be included in the study [RAN1]
Note: The need for RAN2 evaluation will be triggered by RAN1 when
necessary.

The study will consider the usage of a separate low-power wake-up receiver at the UE, and evaluate how that can reduce the UE power consumption. The intention is that the main radio of the UE can be in a sleep mode (or even powered off) for power saving and be activated only upon the reception of the wake-up signal from the network. Basically, the network triggers the UE to wake-up exactly when needed in an event-driven manner, by transmitting a special WUS to the UE, which is monitored by the dedicated low-power WUS receiver at the UE. When a UE receives the WUS, the WUS receiver can trigger the wake-up of the ordinary NR transceiver and communication can start. Thus, the ultra-low power receiver wakes up the main radio and otherwise, the main radio is OFF or kept in a deep sleep mode.

Hereinafter, principles and embodiments of the present disclosure will be described in detail below with reference to the accompanying drawings.

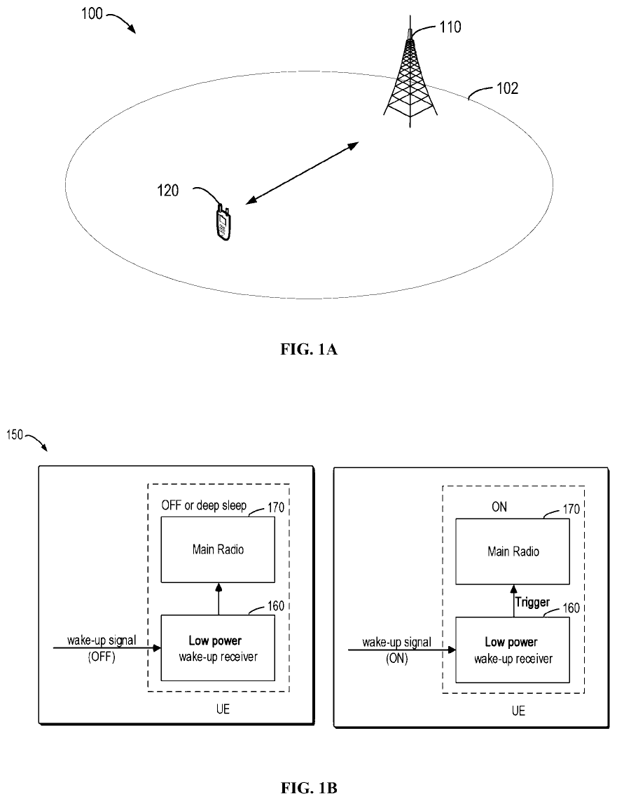

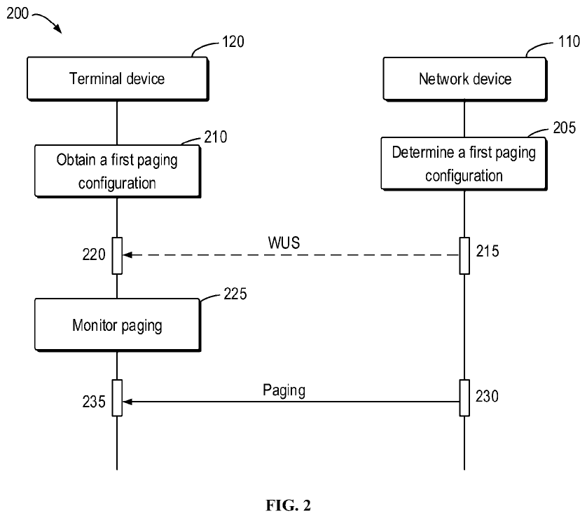

FIG. 1A illustrates an example of a network environment 100 in which some example embodiments of the present disclosure may be implemented. In the descriptions of the example embodiments of the present disclosure, the network environment 100 may also be referred to as a communication system 100 (for example, a portion of a communication network). For illustrative purposes only, various aspects of example embodiments will be described in the context of one or more terminal devices and network devices that communicate with one another. It should be appreciated, however, that the description herein may be applicable to other types of apparatus or other similar apparatuses that are referenced using other terminology.

The network device 110 can provide services to the terminal device 120, and the network device 110 and the terminal device 120 may communicate data and control information with each other. In some embodiments, the network device 110 and the terminal device 120 may communicate with direct links/channels.

In the communication system 100, a link from the network device 110 to the terminal device 120 is referred to as a downlink (DL), while a link from the terminal device 120 to the network device 110 is referred to as an uplink (UL). In downlink, the network device 110 is a transmitting (TX) device (or a transmitter) and the terminal device 120 is a receiving (RX) device (or a receiver). In uplink, the terminal device 120 is a transmitting (TX) device (or a transmitter) and the network device 110 is a RX device (or a receiver). It is to be understood that the network device 110 may provide one or more serving cells. As illustrated in FIG. 1A, the network device 110 provides one serving cell 102, and the terminal device 120 camps on the serving cell 102. In some embodiments, the network device 110 can provide multiple serving cells. It is to be understood that the number of serving cell(s) shown in FIG. 1A is for illustrative purposes only without suggesting any limitation.

Communications in the network environment 100 may be implemented according to any proper communication protocol(s), comprising, but not limited to, cellular communication protocols of the fourth generation (4G), the fifth generation (5G), the sixth generation (6G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the number of devices and their connection relationships and types shown in FIG. 1A are for illustrative purposes only without suggesting any limitation. The communication system 100 may comprise any suitable number of devices adapted for implementing embodiments of the present disclosure.

As mentioned above, main radio works for data transmission and reception, which can be turned off or set to deep sleep unless it is turned on. This will be described in more detail with reference to FIG. 1B.

FIG. 1B illustrates a schematic diagram of operations of UE 150 with low-power wake-up receiver (WUR) based on which some example embodiments of the present disclosure may be implemented. Such a UE 150 primarily targets low-power WUS/WUR for power-sensitive, small form-factor devices including IoT use cases (such as industrial sensors, controllers) and wearables. Other use cases are not precluded, e.g., XR/smart glasses, smart phones. As illustrated in FIG. 1B, the UE 150 includes a main radio 170 and a separate receiver, i.e., a low-power wake-up receiver 160 (e.g., it may be an ultra-low power wake-up receiver).

The main radio 170 of the UE 150 can be in a sleep mode (or even powered off) for power saving and be activated only upon the reception of the wake-up signal from the network (e.g., from a network device). Basically, the network triggers the UE 150 to wake-up exactly when needed in an event-driven manner, by transmitting a special WUS to the UE 150, which is monitored by the dedicated low-power WUS receiver 160 at the UE 150. When the UE 150 receives the WUS, the WUS receiver 160 can trigger the wake-up of the ordinary NR transceiver (which is included in the main radio 170) and communication can start. Thus, the low-power wake-up receiver 160 wakes up the main radio 170, and otherwise, the main radio 170 is OFF or kept in a deep sleep mode, as shown in FIG. 1B.

Strictly speaking, the power consumption for monitoring wake-up signal depends on the wake-up signal design and the hardware module of the wake-up receiver used for signal detecting and processing. Whereas, the assumption is that the low-power wake-up receiver 160 can be operated in an always ‘on’ manner with very low power consumption. In fact, it is expected that it will consume significantly less power compared to the NR transceiver, by designing a simple (WUS) signal and the use of dedicated hardware for its monitoring, which is only able to receive the WUS.

LP-WUS is currently considered for both Idle/Inactive mode and Connected mode. Current discussions mainly focused on DL reception where LP-WUS can be used to wake up the main radio to receive PDCCH/PDSCH.

UE paging monitoring is defined in TS 38.304 Section 7 as follows. The paging frame (PF) and paging occasion (PO) for paging are determined by the following formulae. SFN for the PF is determined by formula (1), and index (i_s), indicating the index of the PO is determined by formula (2).

$$( SFN + PF\_offset ) mod T = ( T div N ) * ( UE\_ID mod N ) \qquad ( 1 )$$

$$i\_s = floor ( UE\_ID / N ) mod Ns \qquad ( 2 )$$

The following parameters are used for the calculation of PF and i_s in formulae (1) and (2). T represents a DRX cycle of the UE. T is determined by the shortest of the UE specific DRX value(s), if configured by RRC and/or upper layers, and a default DRX value broadcast in system information. In RRC_IDLE state, if UE specific DRX is not configured by upper layers, the default value is applied. N represents a number of total paging frames in T. Ns represents a number of paging occasions for a PF. PF_offset represents an offset used for PF determination. UE_ID is determined by formula (3).

$$UE\_ID = 5 G - S - TMSI mod 10 \qquad ( 3 )$$

There is a potential or additional latency for paging in WUS solutions due to the following case. When a UE wakes up in response of receiving a WUS from the network, it will monitor paging at the paging occasion assigned to it. If the point of waking up is after its paging occasion during the current DRX cycle (that is, when it wakes up, it has missed its paging occasion during current DRX cycle), the UE have to wait to the next DRX cycle, in particular a paging occasion during next DRX cycle, to receive the paging targeted for it. In this case, there will be a long latency from waking up to receiving the paging.

In earlier LP-WUS and paging related discussions, approaches to reduce the latency have been raised. There has been proposed an approach where the PO is ‘dynamic’ so that UE will monitor for paging PDCCH on slots that come certain time offset after the LP-WUS triggering. Alternatively, it has been raised that UE monitors the closest PO, regardless of the UE ID. In this context it is also typically assumed that UE will monitor LP-WUS continuously, and no explicit LP-WUS monitoring occasion is defined.

The baseline assumption for earlier paging enhancements (and also others) that UE behaviour is not mandated as long as the behaviour options are transparent to the network. As an example, Rel-17 introduced Paging Early Indication (PEI) to inform UE whether it needs to monitor actual paging. However, monitoring of PEI is not mandated, and UE may (if it so chooses) monitor paging normally, even if PEI is configured.

For LP-WUS operation similar approach would seem preferable from UE operation perspective, for example to allow UE due to radio conditions or due to mobility measurement scheduling to choose whether it monitors for the LP-WUS (with the low power receiver) or whether it monitors the actual paging (with the main radio).

If dynamic PO approach (as per a conventional solution) is used, UE would, if it does not monitor LP-WUS, need to monitor the paging PDCCH constantly, resulting significant power consumption. Also, it would be impossible for the UE to autonomously configure inter-RAT/frequency measurements if LP-WUS can be sent at any time. And it is problematic if the UE missed the LP-WUS signalling as the PO for the LP-WUS UE is not deterministic.

On the other hand, if to just follow the same DRX cycles for paging as for legacy UEs, considering the long wake up/re-synchronization time for the main receiver upon reception of the wake up signalling from the LP-WUS, the paging latency for LP-WUS UEs would be much longer than other UEs, which is not desirable either.

It is noted that for NR there is SMTC configuration, which only tells UE when it can expect SSBs to be present, but for other RATs such as LTE this does not exist. Hence NR and other RAT measurements would not most likely overlap in time, increasing the chance that WUS and measurements could collide if not restricted.

Hence, in order to reduce the paging latency and maintain the transparent operation UE operation (from NW perspective) on whether UE monitors paging or LP-WUS, some enhancement would be needed.

In the present disclosure, it is proposed that as a part of LP-WUS configuration, LP-WUS capable UEs may be configured with additional/adjusted paging monitoring configuration.

FIG. 2 illustrates a flowchart illustrating a communication process 200 in accordance with some example embodiments of the present disclosure. For the purpose of discussion, the communication process 200 will be described with reference to FIGS. 1A-1B. It would be appreciated that although the communication process 200 has been described referring to the network environment 100 of FIG. 1A, this communication process 200 may be likewise applied to other similar communication scenarios.

In the communication process 200, the network device 110 determines 205 a first paging configuration for a first type of terminal devices which are low power wake-up signal (LP-WUS) capable devices, wherein the first paging configuration is different from a second paging configuration for a second type of terminal devices which are LP-WUS incapable devices. In other words, LP-WUS capable UEs may be configured with additional/adjusted paging monitoring configuration, and the legacy/default paging monitoring configuration may still be applied to LP-WUS incapable UEs.

In some embodiments, the first paging configuration may indicate at least one of: a first discontinuous reception (DRX) cycle, a first number of paging frames in a DRX cycle, and a first number of paging occasions in a paging frame; and the second paging configuration indicates at least one of: a second discontinuous reception (DRX) cycle, a second number of paging frames in a DRX cycle, and a second number of paging occasions in a paging frame.

In some embodiments, the first DRX cycle may be shorter than the second DRX cycle. In some embodiments, the first DRX cycle may be determined by dividing a value of the second DRX cycle with an integer equal to or greater than 2. In some embodiments, the first paging configuration may further indicate a paging frame offset which is the same as a paging frame offset indicated by the second paging configuration.

That is to say, the LP-WUS capable UE is provided with additional DRX cycle, T_wus, which is shorter than the default DRX cycle value, T. In some additional embodiments, additional DRX cycle, T_wus, is determined by dividing DRX cycle value, T with integer e.g. 2, 3, 4 etc. In some related embodiments the (T div N)mod=T_wus, and same PF_offset is assumed for both, to ensure that ‘normal’ POs and additional LP-WUS POs are aligned and can be shared for paging of normal and LP-WUS capable UEs.

In some embodiments, the first number of paging frames may be greater than the second number of paging frames. In some embodiments, the first number of paging frames may be determined by multiplying the second number of paging frames with an integer equal to or greater than 2.

That is to say, the LP-WUS capable UE may be provided with different N value (number of total paging frames in T), N_wus, which is larger than the default N value so that more PF are introduced per DRX cycle, T. In some related embodiment, applied N_wus is determined by scaling (multiplying) the default N value.

In some embodiments, a valid paging frame determination for the terminal device may be based on the first number of paging frames rather than the second number of paging frames. In some alternative embodiments, a valid paging frame determination for the terminal device may be based on the second number of paging frames, and the first number of paging frames is applied in paging the terminal device.

That is to say, the valid PF selection may be based on N_wus rather than N. In some related embodiment, the valid PF/PO selection could be based on N, while the number of PFs in T is set by N_wus, (where N_ws>N). In some related embodiments N_wus, rather than N is used to determine to which radio frames the PFs are mapped.

In some embodiments, the first number of paging occasions may be greater than the second number of paging occasions. In some embodiments, a valid paging occasion determination for the terminal device may be based on the first number of paging occasions rather than the second number of paging occasions. In some alternative embodiments, a valid paging occasion determination for the terminal device may be based on the second number of paging occasions, and the first number of paging occasions is applied in paging the terminal device.

That is to say, the LP-WUS capable UE may be provided different value for the number of POs in PF, i.e. Ns_wus in addition to the Ns. In some related embodiment, the valid PO selection may be based on Ns_wus rather than Ns. In some related embodiment, the valid PO selection may be based on Ns, while the number of POs is set by Ns_wus, (where Ns_ws>Ns).

In some embodiments, the first paging configuration comprises an indication of whether an ID of the terminal device is used to select at least one paging frame or at least one paging occasion to be monitored. In other words, the LP-WUS capable UE may be provided an optional indication whether the UE_ID is used to select the applied/monitored PF. In some related embodiment, it may also be defined whether the UE_ID is used in selection of monitored POs.

Continuing with reference to FIG. 2, the network device 110 may transmit, to the terminal device 120, the first paging configuration. In some embodiments, the network device 110 may transmit, to the terminal device 120, the first paging configuration via dedicated and/or broadcast signaling. In some embodiments, the dedicated signaling may be an RRC_Release message. In some embodiments, the broadcast signaling may be system information (e.g. SIB). That is to say, above additional/adjusted paging monitoring configuration (the first paging configuration) is provided to the UE using dedicated (e.g. RRC Release message) and/or broadcast signaling (system information e.g. SIB). In some embodiments, the first paging configuration may explicitly or implicitly be indicated in the signaling.

As shown in FIG. 2, on the UE side, the terminal device 120 which is a LP-WUS capable device obtains 210 a first paging configuration for a first type of terminal devices which are low power wake-up signal (LP-WUS) capable devices, wherein the first paging configuration is different from a second paging configuration for a second type of terminal devices which are LP-WUS incapable devices. As said above, the obtaining of the first paging configuration may be by receiving it from the network device 110, for example, receiving it via dedicated (e.g. RRC Release message) and/or broadcast signaling (system information e.g. SIB). In some embodiments, the first paging configuration may explicitly or implicitly be indicated in the signaling. In some embodiments, the terminal device 120 may derive the first paging configuration from an indication transmitted by the network side and/or from a certain agreement with the network side. It is to be understood that the terminal device 120 may use any other ways to obtain the first paging configuration, and the scope of the present disclosure is not limited in this regard.

As said above, if the network device 110 needs to page the terminal device 120 which is a LP-WUS capable device, it may first transmits 215 a WUS to the terminal device 120, so that the terminal device 120 may wake up and start the main radio to monitor paging.

On the UE side, upon reception 220 of the WUS through a LP_WUS receiver, the terminal device 120 may start the main radio to monitor paging. The terminal device 120 monitor 225 a paging message according to the first paging configuration, based on determining that the terminal device 120 is a LP-WUS capable device. In some embodiments, the terminal device 120 may choose to directly monitor 225 a paging message according to the first paging configuration without receiving the WUS through the LP_WUS receiver. That is to say, the terminal device 120 may choose whether it monitors for the LP-WUS (with the low power receiver) or whether it monitors the actual paging (with the main radio). In other words, UEs are allow, due to radio conditions or due to mobility measurement scheduling, to choose whether it monitors for the LP-WUS (with the low power receiver) or whether it monitors the actual paging (with the main radio).

On the network side, after transmitting the WUS, the network device 110 transmits 230 a paging message to the terminal device 120 according to the first paging configuration, based on determining that the terminal device 120 is a LP-WUS capable device.

On the other hand, because the terminal device 120 is aware of the first paging configuration, and it is monitoring according to the first paging configuration, it is able to receive 235 the paging message successfully.

Through the process flow 200, a mechanism for LP-WUS paging may be provided, and in particular, LP-WUS capable UEs may be configured with additional/adjusted paging monitoring configuration. In this way, it may enable reducing paging latency for LP-WUS based operation; further, it still adopts deterministic POs to ensure there is no misalignment even if the LP-WUS capable UE missed LP-WUS for some reason e.g. due to radio condition or measurement; in addition, it maintains the UE flexibility to choose whether to monitor LP-WUS or normal paging, and keeps the UE behavior transparent to the network.

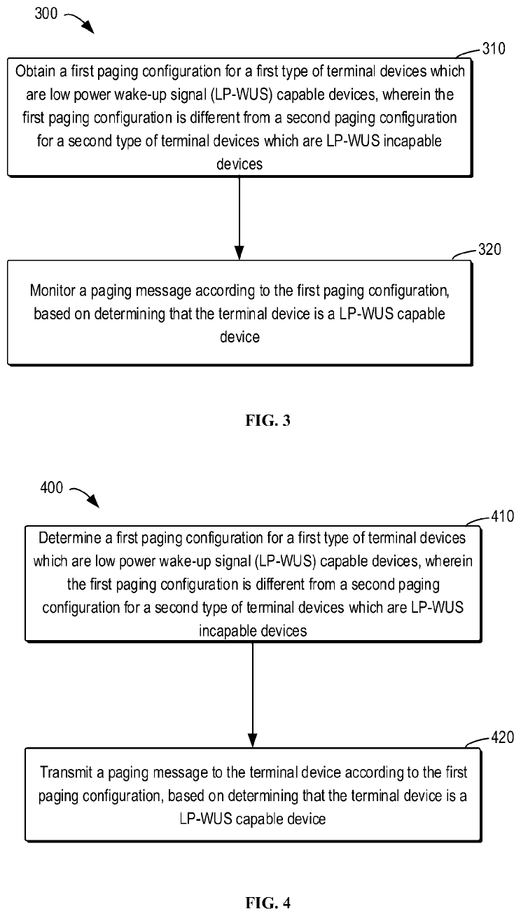

FIG. 3 illustrates a flowchart of an example method 300 implemented at a terminal device 120 in accordance with some other embodiments of the present disclosure. For the purpose of discussion, the method 300 will be described from the perspective of the terminal device 120 with reference to FIGS. 1A-2.

At block 310, the terminal device 120 obtains a first paging configuration for a first type of terminal devices which are low power wake-up signal (LP-WUS) capable devices, wherein the first paging configuration is different from a second paging configuration for a second type of terminal devices which are LP-WUS incapable devices. At block 320, the terminal device 120 monitors a paging message according to the first paging configuration, based on determining that the terminal device 120 is a LP-WUS capable device.

In some embodiments, the first paging configuration indicates at least one of: a first discontinuous reception (DRX) cycle, a first number of paging frames in a DRX cycle, and a first number of paging occasions in a paging frame; and the second paging configuration indicates at least one of: a second discontinuous reception (DRX) cycle, a second number of paging frames in a DRX cycle, and a second number of paging occasions in a paging frame.

In some embodiments, the first DRX cycle is shorter than the second DRX cycle. In some embodiments, the first DRX cycle is determined by dividing a value of the second DRX cycle with an integer equal to or greater than 2.

In some embodiments, the first paging configuration further indicates a paging frame offset which is the same as a paging frame offset indicated by the second paging configuration.

In some embodiments, the first number of paging frames is greater than the second number of paging frames. In some embodiments, the first number of paging frames is determined by multiplying the second number of paging frames with an integer equal to or greater than 2.

In some embodiments, a valid paging frame determination for the terminal device is based on the first number of paging frames rather than the second number of paging frames. In some embodiments, a valid paging frame determination for the terminal device is based on the second number of paging frames, and the first number of paging frames is applied in paging the terminal device.

In some embodiments, the first number of paging occasions is greater than the second number of paging occasions. In some embodiments, a valid paging occasion determination for the terminal device is based on the first number of paging occasions rather than the second number of paging occasions. In some embodiments, a valid paging occasion determination for the terminal device is based on the second number of paging occasions, and the first number of paging occasions is applied in paging the terminal device.

In some embodiments, the first paging configuration comprises an indication of whether an ID of the terminal device is used to select at least one paging frame or at least one paging occasion to be monitored.

In some embodiments, the terminal device is caused to monitor the paging message by: based on receiving a LP-WUS, monitoring the paging message.

In some embodiments, the terminal device is caused to obtain the first paging configuration by: receiving the first paging configuration from a network device. In some embodiments, the first paging configuration is received via at least one of dedicated signaling or broadcast signaling.

FIG. 4 illustrates another flowchart of an example method 400 implemented at a network device 110 in accordance with some other embodiments of the present disclosure. For the purpose of discussion, the method 400 will be described from the perspective of the network device 110 with reference to FIGS. 1A-2.

At block 410, the network device 110 determines a first paging configuration for a first type of terminal devices which are low power wake-up signal (LP-WUS) capable devices, wherein the first paging configuration is different from a second paging configuration for a second type of terminal devices which are LP-WUS incapable devices. At block 420, the network device 110 transmits a paging message to the terminal device according to the first paging configuration, based on determining that the terminal device is a LP-WUS capable device.

In some embodiments, the first paging configuration indicates at least one of: a first discontinuous reception (DRX) cycle, a first number of paging frames in a DRX cycle, and a first number of paging occasions in a paging frame; and the second paging configuration indicates at least one of: a second discontinuous reception (DRX) cycle, a second number of paging frames in a DRX cycle, and a second number of paging occasions in a paging frame.

In some embodiments, the first DRX cycle is shorter than the second DRX cycle. In some embodiments, the first DRX cycle is determined by dividing a value of the second DRX cycle with an integer equal to or greater than 2.

In some embodiments, the first paging configuration further indicates a paging frame offset which is the same as a paging frame offset indicated by the second paging configuration.

In some embodiments, the first number of paging frames is greater than the second number of paging frames. In some embodiments, the first number of paging frames is determined by multiplying the second number of paging frames with an integer equal to or greater than 2.

In some embodiments, a valid paging frame determination for the terminal device is based on the first number of paging frames rather than the second number of paging frames. In some embodiments, a valid paging frame determination for the terminal device is based on the second number of paging frames, and the first number of paging frames is applied in paging the terminal device.

In some embodiments, the first number of paging occasions is greater than the second number of paging occasions. In some embodiments, a valid paging occasion determination for the terminal device is based on the first number of paging occasions rather than the second number of paging occasions. In some embodiments, a valid paging occasion determination for the terminal device is based on the second number of paging occasions, and the first number of paging occasions is applied in paging the terminal device.

In some embodiments, the first paging configuration comprises an indication of whether an ID of the terminal device is used to select at least one paging frame or at least one paging occasion to be monitored.

In some embodiments, the network device further transmits, to the terminal device, the first paging configuration. In some embodiments, the first paging configuration is transmitted via at least one of dedicated signaling or broadcast signaling.

In some embodiments, an apparatus capable of performing the method 300 (for example, the terminal device 120) may comprise means for performing the respective steps of the method 300. The means may be implemented in any suitable form. For example, the means may be implemented in a circuitry or software module.

In some example embodiments, the apparatus comprises: means for obtaining a first paging configuration for a first type of terminal devices which are low power wake-up signal (LP-WUS) capable devices, wherein the first paging configuration is different from a second paging configuration for a second type of terminal devices which are LP-WUS incapable devices; and means for monitoring a paging message according to the first paging configuration, based on determining that the terminal device is a LP-WUS capable device.

In some embodiments, the OnDuration timer may be started or restarted at a time point based on receiving the LP-WUS from the network device 110.

In some embodiments, the first paging configuration indicates at least one of: a first discontinuous reception (DRX) cycle, a first number of paging frames in a DRX cycle, and a first number of paging occasions in a paging frame; and the second paging configuration indicates at least one of: a second discontinuous reception (DRX) cycle, a second number of paging frames in a DRX cycle, and a second number of paging occasions in a paging frame.

In some embodiments, the first DRX cycle is shorter than the second DRX cycle. In some embodiments, the first DRX cycle is determined by dividing a value of the second DRX cycle with an integer equal to or greater than 2.

In some embodiments, the first paging configuration further indicates a paging frame offset which is the same as a paging frame offset indicated by the second paging configuration.

In some embodiments, the first number of paging frames is greater than the second number of paging frames. In some embodiments, the first number of paging frames is determined by multiplying the second number of paging frames with an integer equal to or greater than 2.

In some embodiments, a valid paging frame determination for the terminal device is based on the first number of paging frames rather than the second number of paging frames. In some embodiments, a valid paging frame determination for the terminal device is based on the second number of paging frames, and the first number of paging frames is applied in paging the terminal device.

In some embodiments, the first number of paging occasions is greater than the second number of paging occasions. In some embodiments, a valid paging occasion determination for the terminal device is based on the first number of paging occasions rather than the second number of paging occasions. In some embodiments, a valid paging occasion determination for the terminal device is based on the second number of paging occasions, and the first number of paging occasions is applied in paging the terminal device.

In some embodiments, the first paging configuration comprises an indication of whether an ID of the terminal device is used to select at least one paging frame or at least one paging occasion to be monitored.

In some embodiments, the means for monitoring the paging message comprises means for, based on receiving a LP-WUS, monitoring the paging message.

In some embodiments, the means for obtaining the first paging configuration comprises means for receiving the first paging configuration from a network device. In some embodiments, the first paging configuration is received via at least one of dedicated signaling or broadcast signaling.

In some embodiments, the apparatus further comprises means for performing other steps in some embodiments of the method 300. In some embodiments, the means comprises at least one processor and at least one memory including computer program code, the at least one memory and computer program code configured to, with the at least one processor, cause the performance of the apparatus.

In some embodiments, an apparatus capable of performing the method 400 (for example, the network device 110) may comprise means for performing the respective steps of the method 400. The means may be implemented in any suitable form. For example, the means may be implemented in a circuitry or software module.

In some example embodiments, the apparatus comprises: means for determining a first paging configuration for a first type of terminal devices which are low power wake-up signal (LP-WUS) capable devices, wherein the first paging configuration is different from a second paging configuration for a second type of terminal devices which are LP-WUS incapable devices; and means for transmitting a paging message to the terminal device according to the first paging configuration, based on determining that the terminal device is a LP-WUS capable device.

In some embodiments, the first paging configuration indicates at least one of: a first discontinuous reception (DRX) cycle, a first number of paging frames in a DRX cycle, and a first number of paging occasions in a paging frame; and the second paging configuration indicates at least one of: a second discontinuous reception (DRX) cycle, a second number of paging frames in a DRX cycle, and a second number of paging occasions in a paging frame.

In some embodiments, the first DRX cycle is shorter than the second DRX cycle. In some embodiments, the first DRX cycle is determined by dividing a value of the second DRX cycle with an integer equal to or greater than 2.

In some embodiments, the first paging configuration further indicates a paging frame offset which is the same as a paging frame offset indicated by the second paging configuration.

In some embodiments, the first number of paging frames is greater than the second number of paging frames. In some embodiments, the first number of paging frames is determined by multiplying the second number of paging frames with an integer equal to or greater than 2.

In some embodiments, a valid paging frame determination for the terminal device is based on the first number of paging frames rather than the second number of paging frames. In some embodiments, a valid paging frame determination for the terminal device is based on the second number of paging frames, and the first number of paging frames is applied in paging the terminal device.

In some embodiments, the first number of paging occasions is greater than the second number of paging occasions. In some embodiments, a valid paging occasion determination for the terminal device is based on the first number of paging occasions rather than the second number of paging occasions. In some embodiments, a valid paging occasion determination for the terminal device is based on the second number of paging occasions, and the first number of paging occasions is applied in paging the terminal device.

In some embodiments, the first paging configuration comprises an indication of whether an ID of the terminal device is used to select at least one paging frame or at least one paging occasion to be monitored.

In some embodiments, the apparatus further comprises means for transmitting, to the terminal device, the first paging configuration. In some embodiments, the first paging configuration is transmitted via at least one of dedicated signaling or broadcast signaling.

In some embodiments, the apparatus further comprises means for performing other steps in some embodiments of the method 400. In some embodiments, the means comprises at least one processor and at least one memory including computer program code, the at least one memory and computer program code configured to, with the at least one processor, cause the performance of the apparatus.

FIG. 5 illustrates a simplified block diagram of a device 500 that is suitable for implementing some example embodiments of the present disclosure. The device 500 may be provided to implement a communication device, for example, the network device 110 or the terminal device 120 as shown in FIG. 1A. As shown, the device 500 includes one or more processors 510, one or more memories 520 coupled to the processor 510, and one or more communication modules 540 coupled to the processor 510.

The communication module 540 is for bidirectional communications. The communication module 540 has at least one antenna to facilitate communication. The communication interface may represent any interface that is necessary for communication with other network elements.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The program 530 may be stored in the ROM 524. The processor 510 may perform any suitable actions and processing by loading the program 530 into the RAM 522.

The embodiments of the present disclosure may be implemented by means of the program 530 so that the device 500 may perform any process of the disclosure as discussed with reference to FIG. 2. The embodiments of the present disclosure may also be implemented by hardware or by a combination of software and hardware.

In some example embodiments, the program 530 may be tangibly contained in a computer-readable medium which may be included in the device 500 (such as in the memory 520) or other storage devices that are accessible by the device 500. The device 500 may load the program 530 from the computer-readable medium to the RAM 522 for execution. The computer-readable medium may include any types of tangible non-volatile storage, such as ROM, EPROM, a flash memory, a hard disk, CD, DVD, and the like.

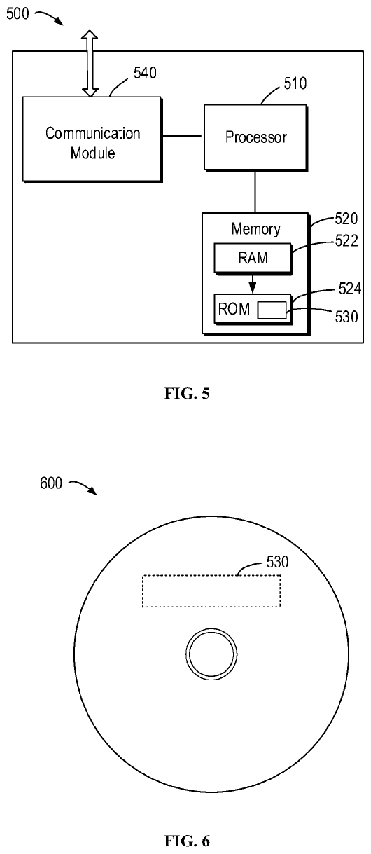

FIG. 6 illustrates a block diagram of an example of a computer-readable medium 1000 in accordance with some example embodiments of the present disclosure. The computer-readable medium 600 has the program 530 stored thereon. It is noted that although the computer-readable medium 600 is depicted in form of CD or DVD in FIG. 6, the computer-readable medium 600 may be in any other form suitable for carry or hold the program 530.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer-readable storage medium. The computer program product includes computer-executable instructions, such as those included in program modules, being executed in a device on a target real or virtual processor, to carry out the method 300 or 400 as described above with reference to FIG. 3 or 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer-readable medium, and the like.

The computer-readable medium may be a computer-readable signal medium or a computer-readable storage medium. A computer-readable medium may include but not limited to an electronic, magnetic, optical, electromagnetic, infrared, or semiconductor system, apparatus, or device, or any suitable combination of the foregoing. More specific examples of the computer-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

### List of Abbreviations

LP-WUS Low Power Wake-Up Signal
WI Wake-Up Indicator
MAC Medium Access Control
DRX Discontinuous Reception
BBP Baseband Processor
WUR Wake-Up Receiver
eDRX extended Discontinuous Reception
IoT Internet of Things
PDCCH Physical Downlink Control CHannel
PDSCH Physical Downlink Shared CHannel
DCI Downlink Control Information
RRC Radio Resource Control
PEI Paging Early Indication

1. A terminal device comprising:
at least one processor; and
at least one memory storing instructions that, when executed by the at least one processor, cause the terminal device at least to:
obtain a first paging configuration for a first type of terminal devices which are low power wake-up signal (LP-WUS) capable devices, wherein the first paging configuration is different from a second paging configuration for a second type of terminal devices which are LP-WUS incapable devices; and
monitor a paging message according to the first paging configuration, based on determining that the terminal device is a LP-WUS capable device.

2. The terminal device of claim 1, wherein the first paging configuration indicates at least one of: a first discontinuous reception (DRX) cycle, a first number of paging frames in a DRX cycle, or a first number of paging occasions in a paging frame; and the second paging configuration indicates at least one of: a second discontinuous reception (DRX) cycle, a second number of paging frames in a DRX cycle, or a second number of paging occasions in a paging frame.

3. The terminal device of claim 2, wherein the first DRX cycle is shorter than the second DRX cycle.

4. The terminal device of claim 3, wherein the first DRX cycle is determined by dividing a value of the second DRX cycle with an integer equal to or greater than 2.

5. The terminal device of claim 4, wherein the first paging configuration further indicates a paging frame offset which is the same as a paging frame offset indicated by the second paging configuration.

6. The terminal device of claim 2, wherein the first number of paging frames is greater than the second number of paging frames.

7. The terminal device of claim 6, wherein the first number of paging frames is determined by multiplying the second number of paging frames with an integer equal to or greater than 2.

8. The terminal device of claim 2, wherein a valid paging frame determination for the terminal device is based on the first number of paging frames rather than the second number of paging frames.

9. The terminal device of claim 2, wherein a valid paging frame determination for the terminal device is based on the second number of paging frames, and the first number of paging frames is applied in paging the terminal device.

10. The terminal device of claim 2, wherein the first number of paging occasions is greater than the second number of paging occasions.

11. The terminal device of claim 2, wherein a valid paging occasion determination for the terminal device is based on the first number of paging occasions rather than the second number of paging occasions.

12. The terminal device of claim 2, wherein a valid paging occasion determination for the terminal device is based on the second number of paging occasions, and the first number of paging occasions is applied in paging the terminal device.

13. The terminal device of claim 1, wherein the first paging configuration comprises an indication of whether an ID of the terminal device is used to select at least one paging frame or at least one paging occasion to be monitored.

14. The terminal device of claim 1, wherein the terminal device is caused to monitor the paging message by:
based on receiving a LP-WUS, monitoring the paging message.

15. The terminal device of claim 1, wherein the terminal device is caused to obtain the first paging configuration by:
receiving the first paging configuration from a network device.

16. The terminal device of claim 15, wherein the first paging configuration is received via at least one of dedicated signaling or broadcast signaling.

17. A network device comprising:
at least one processor; and
at least one memory storing instructions that, when executed by the at least one processor, cause the network device at least to:
determine a first paging configuration for a first type of terminal devices which are low power wake-up signal (LP-WUS) capable devices, wherein the first paging configuration is different from a second paging configuration for a second type of terminal devices which are LP-WUS incapable devices; and
transmit a paging message to the terminal device according to the first paging configuration, based on determining that the terminal device is a LP-WUS capable device.

18. The network device of claim 17, wherein the first paging configuration indicates at least one of: a first discontinuous reception (DRX) cycle, a first number of paging frames in a DRX cycle, or a first number of paging occasions in a paging frame; and the second paging configuration indicates at least one of: a second discontinuous reception (DRX) cycle, a second number of paging frames in a DRX cycle, or a second number of paging occasions in a paging frame.

19. The network device of claim 18, wherein the first DRX cycle is shorter than the second DRX cycle.

20. (canceled)

21. (canceled)

22. The network device of claim 18, wherein the first number of paging frames is greater than the second number of paging frames.

23. (canceled)

24. The network device of claim 18, wherein a valid paging frame determination for the terminal device is based on the first number of paging frames rather than the second number of paging frames.

25. The network device of claim 18, wherein a valid paging frame determination for the terminal device is based on the second number of paging frames, and the first number of paging frames is applied in paging the terminal device.

26. The network device of claim 18, wherein the first number of paging occasions is greater than the second number of paging occasions.

27. The network device of claim 18, wherein a valid paging occasion determination for the terminal device is based on the first number of paging occasions rather than the second number of paging occasions.

28. The network device of claim 18, wherein a valid paging occasion determination for the terminal device is based on the second number of paging occasions, and the first number of paging occasions is applied in paging the terminal device.

29. The network device of claim 17, wherein the first paging configuration comprises an indication of whether an ID of the terminal device is used to select at least one paging frame or at least one paging occasion to be monitored.

30. The network device of claim 17, wherein the network device is further caused to:
transmit, to the terminal device, the first paging configuration.

31-36. (canceled)
